(19) United States
(12) Patent Application Publication
(10) Pub. No.: US 2009/0150783 A1
(43) Pub. Date: Jun. 11, 2009

(54) METHOD AND APPARATUS TO CONTROL DEVICE

(75) Inventors: Ju-hee Seo, Hwaseong-si (KR); Houng-sog Min, Ansan-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 12/171,416

(22) Filed: Jul. 11, 2008

(30) Foreign Application Priority Data
Dec. 5, 2007 (KR) 2007-125768

(51) Int. Cl. G06F 3/048

(52) U.S. Cl. 715/721

(57) ABSTRACT

A method of controlling one or more devices by using a broadcasting receiving apparatus includes operations of collecting one or more pieces of information from the one or more devices such that the information corresponds to the one or more devices and contents stored in the one or more devices, generating a user interface by using the collected information and a user interface of the broadcasting receiving apparatus in order to control the one or more devices, and controlling the one or more devices based on a control command input via the generated user interface.

### CROSS-REFERENCE TO RELATED APPLICATIONS

This application claims priority under 35 U.S.C. §119(a) from Korean Patent Application No. 10-2007-0125768, filed on Dec. 5, 2007, in the Korean Intellectual Property Office, the disclosure of which is incorporated herein in its entirety by reference.

### BACKGROUND OF THE INVENTION

1. Field of the Invention

The present general inventive concept relates to a method and apparatus to control a device, and more particularly, to a method and apparatus to control a device by using a broadcasting receiving apparatus.

2. Description of the Related Art

Due to the rapid development of digital technologies, various types of digital devices such as a digital camera, a digital camcorder, a portable moving picture player, an MPEG Audio Layer-3 (MP3) player, and the like, have been created. Due to the creation of such various types of digital devices, users are inconvenienced since the users have to separately learn how to manipulate each of the digital devices because the digital devices have different manipulation methods.

In order to solve such an inconvenience, a method of connecting the digital devices to a computer and controlling the connected digital devices has been proposed. However, difficulty to intuitively manipulate the computer exists, thereby causing an inconvenience to users.

### SUMMARY OF THE INVENTION

The present general inventive concept provides a method and apparatus to intuitively control various types of digital devices.

Additional aspects and utilities of the present general inventive concept will be set forth in part in the description which follows and, in part, will be obvious from the description, or may be learned by practice of the general inventive concept.

The foregoing and/or other aspects and utilities of the general inventive concept may be achieved by providing a method of controlling one or more devices by using a broadcasting receiving apparatus, the method including operations of collecting one or more pieces of information from the one or more devices such that the information corresponds to the one or more devices and contents stored in the one or more devices, generating a user interface by using the collected information and a user interface of the broadcasting receiving apparatus in order to control the one or more devices, and controlling the one or more devices based on a control command input via the generated user interface.

The method may further include the operation of receiving an electronic program guide (EPG), wherein the operation of generating the user interface may include the operation of generating the user interface based on the received EPG and the collected information.

The operation of generating the user interface may further include the operations of generating one or more virtual channels in the received EPG matching the one or more devices with the one or more virtual channels by using the collected information, and generating the user interface by using the one or more virtual channels.

The operation of matching may further include the operations of generating one or more virtual programs in the received EPG, and matching the contents stored in the one or more devices with the one or more virtual programs.

When the contents are stored in the one or more devices having a structure including directories, the operation of matching may further include the operation of matching the directories of the one or more devices with the one or more virtual channels generated in the received EPG or with the one or more virtual programs generated in the received EPG.

The operation of matching may further include the operation of matching each category classifying the contents stored in the one or more devices, with each of the one or more virtual programs generated in the received EPG.

Titles of the one or more virtual channels may be determined by using one of a title indicating each type of the one or more devices, a serial number of each of the one or more devices, a title pre-decided by a user or a manufacturer, and a title directly input by a user, and titles of the one or more virtual programs may be decided by using one of a title indicating a type of the contents, a title pre-decided by a user or a manufacturer, and a title directly input by a user.

The operation of controlling may include one or more of controlling the contents, which are stored in the one or more devices, to be deleted or to be executed, the operation of controlling the contents to be reproduced via the broadcasting receiving apparatus, or the operation of controlling the contents to be transmitted between each of the one or more devices.

The foregoing and/or other aspects and utilities of the general inventive concept may also be achieved by providing a device control apparatus to control one or more devices by using a broadcasting receiving apparatus, the apparatus including an information collection unit to collect one or more pieces of information from the one or more devices such that the information corresponds to the one or more devices and contents stored in the one or more devices, a user interface generation unit to generate a user interface by using the collected information and a user interface of the broadcasting receiving apparatus in order to control the one or more devices, an input unit to receive a control command via the generated user interface, and a control unit to control the one or more devices based on the input control command.

The device control apparatus may further include a receiving unit to receive an EPG, wherein the user interface generation unit may generate the user interface based on the received EPG and the collected information.

The user interface generation unit may further include a match unit to generate one or more virtual channels in the received EPG, and to match the one or more devices with the one or more virtual channels by using the collected information, and an interface generation unit to generate the user interface by using the one or more virtual channels.

The foregoing and/or other aspects and utilities of the general inventive concept may also be achieved by providing a computer-readable recording medium having embodied thereon a computer program to execute a method, the method including collecting one or more pieces of information from the one or more devices such that the information corresponds to the one or more devices and contents stored in the one or more devices, generating a user interface by using the collected information and a user interface of the broadcasting receiving apparatus in order to control the one or more devices, and controlling the one or more devices based on a control command input via the generated user interface.

The foregoing and/or other aspects and utilities of the general inventive concept may also be achieved by providing a control apparatus usable with a broadcasting receiving apparatus, the control apparatus including a user interface generation unit to generate a user interface by using information from one or more devices and an electronic program guide received by the broadcasting receiving apparatus, wherein the user interface is generated in order to control the one or more devices.

The control apparatus may further include a control unit to control the one or more devices based on an input control command.

The one or more devices may include at least one of a digital camera, a portable media player and a personal computer.

### BRIEF DESCRIPTION OF THE DRAWINGS

The above and other features and utilities of the present general inventive concept will become more apparent by describing in detail exemplary embodiments thereof with reference to the attached drawings in which:

FIG. 1 is a block diagram illustrating an apparatus to control a device by using a broadcasting receiving apparatus, according to an embodiment of the present general inventive concept;

FIG. 2 is a block diagram illustrating a user interface generation unit of the apparatus of FIG. 1;

FIG. 3 is a diagram illustrating a user interface according to an embodiment of the present general inventive concept;

FIG. 4 is a diagram illustrating a user interface according to another embodiment of the present general inventive concept;

FIG. 5 is a block diagram illustrating an apparatus to control a device by using a broadcasting receiving apparatus, according to another embodiment of the present general inventive concept; and

FIG. 6 is a flowchart illustrating a method of controlling a device by using a broadcasting receiving apparatus, according to an embodiment of the present general inventive concept.

### DETAILED DESCRIPTION OF THE PREFERRED EMBODIMENTS

Reference will now be made in detail to embodiments of the present general inventive concept, examples of which are illustrated in the accompanying drawings, wherein like reference numerals refer to the like elements throughout. The embodiments are described below in order to explain the present general inventive concept by referring to the figures.

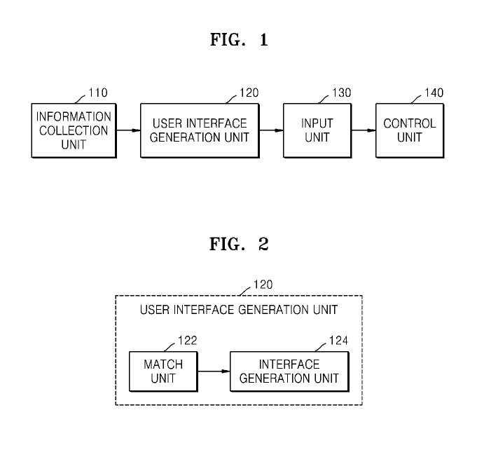

FIG. 1 is a block diagram illustrating an apparatus to control a device by using a broadcasting receiving apparatus, according to an embodiment of the present general inventive concept.

Referring to FIG. 1, the apparatus to control the device (hereinafter, referred to as ‘device control apparatus’) according to the present general inventive concept includes an information collection unit 110, a user interface generation unit 120, an input unit 130, and a control unit 140.

The information collection unit 110 collects one or more pieces of information from one or more devices, wherein the information is about each of the one or more devices and about contents stored in each of the one or more devices.

The one or more devices include various types of digital devices such as a digital camera, a digital camcorder, a portable moving picture player, an MPEG Audio Layer-3 (MP3) player, and the like.

Here, the information about the one or more devices represents all pieces of information related to the one or more devices, such as a type of the one or more devices, serial numbers of the one or more devices, and functions supported by the one or more devices. The information collection unit 110 collects the information, that is related to the one or more devices, from the one or more devices that are wirelessly or wiredly connected to the device control apparatus according to the present embodiment.

Also, the information about the contents may be a type of the contents, and titles of the contents. In the case where the contents are stored in a directory of each of the one or more devices, the information about the contents may be a name of the directory.

The user interface generation unit 120 generates a user interface to control the one or more devices by using a user interface of the broadcasting receiving apparatus and the information collected by the information collection unit 110.

In this manner, the device control apparatus according to the present embodiment is connected to the broadcasting receiving apparatus or is equipped in the broadcasting receiving apparatus, thereby controlling the one or more devices by using the user interface of the broadcasting receiving apparatus, which is more intuitive and familiar to users. Thus, the device control apparatus may enable the users to more easily manipulate the one or more devices.

The user interface of the broadcasting receiving apparatus may be in a text form or may be a graphic user interface (GUI).

Also, the broadcasting receiving apparatus includes all types of apparatuses such as an analog television (TV), a digital TV, an internet protocol TV (IPTV), and the like which can receive a broadcasting.

Meanwhile, the user interface generation unit 120 may generate the user interface by using not only the user interface included in the broadcasting receiving apparatus but also by using an electronic program guide (EPG) externally received.

The device control apparatus according to the present embodiment may further include a receiving unit (not illustrated) to receive the EPG.

A detailed description of the user interface generation unit 120 is to be described later with reference to FIGS. 2 through 4.

The input unit 130 (FIG. 1) receives a control command via the user interface generated by the user interface generation unit 120.

The input unit 130 may receive the control command via an external input device such as a remote controller.

In this manner, the device control apparatus according to the present embodiment is configured so as to receive the control command via the remote controller and the like which are familiar to users, thereby improving user convenience in terms of controlling the one or more devices.

When the control command is input to the input unit 130 (FIG. 1) via the user interface generated by the user interface generation unit 120, the control unit 140 controls the one or more devices based on the input control command.

The control unit 140 (FIG. 1) may control the contents, which are stored in the one or more devices, to be deleted or to be executed, may control the contents to be reproduced in the broadcasting receiving apparatus, or may control the contents, which are stored in the one or more devices, to be transmitted between each of the one or more devices.

FIG. 2 is a diagram illustrating the user interface generation unit 120 of the device control apparatus of FIG. 1.

Referring to FIGS. 1 and 2, the user interface generation unit 120 according to the current embodiment includes a match unit 122 and an interface generation unit 124.

The match unit 122 generates one or more virtual channels in the EPG received by the receiving unit, and matches the one or more virtual channels respectively with the one or more devices by using the information collected by the information collection unit 110.

For example, in the case where a digital camera and an MP3 player are connected to the device control apparatus according to the present embodiment, the match unit 122 generates two virtual channels and respectively matches the two virtual channels with the digital camera and the MP3 player.

Also, the match unit 122 may generate one or more virtual programs in the EPG received by the receiving unit and may match the contents, which are stored in the one or more devices, with the one or more virtual programs.

The interface generation unit 124 generates the user interface by using one of the one or more virtual channels and the one or more virtual programs.

For example, in the above example, the interface generation unit 124 may decide that a title of one of the two virtual channels is “Device 1” which corresponds to the digital camera, and may decide that a title of the other one of the two virtual channels is “Device 2” which corresponds to the MP3 player. After that, the interface generation unit 124 may generate the user interface by using the two virtual channels having the decided titles and by using virtual programs corresponding to the two virtual channels.

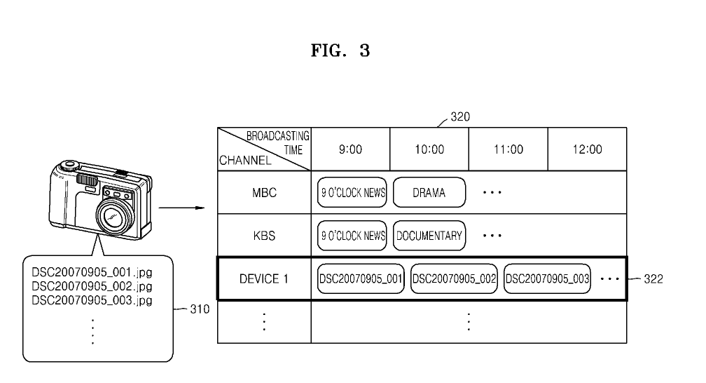

FIG. 3 is a diagram illustrating a user interface 320 according to an embodiment of the present general inventive concept.

Referring to FIG. 3, the user interface 320 generated based on pictures 310 stored in a digital camera is illustrated.

The user interface 320 of FIG. 3 is generated by using the EPG received by the receiving unit. In a side column of the user interface 320, broadcasting channels “MBC” and “KBS”, and virtual channels, such as virtual channel “Device 1”, are indicated. Also, in a top row of the user interface 320, programs such as the “9 O'Clock News”, and “Drama”, which are programs corresponding to the broadcasting channel “MBC”, are indicated according to broadcasting time, and programs such as the “9 O'Clock News” and “a documentary film”, which are programs corresponding to the broadcasting channel “KBS”, are indicated according to broadcasting time. Also, in a block 322, the contents “DSC20070905_{—}001, DSC20070905_{—}002, DSC20070905_{—}003” corresponding to the virtual channel “Device 1”, are indicated.

The virtual channel “Device 1” in the block 322 corresponds to the digital camera, and the contents “DSC20070905_{—}001, DSC20070905_{—}002, DSC20070905_{—}003” correspond to the pictures 310 stored in the digital camera.

In FIG. 3, a title of the virtual channel is indicated as “Device 1”. However, the present general inventive concept is not limited thereto, and thus, such a title of the virtual channel may be a title such as “Digital Camera” that indicates a device type, may be a serial number of the device, may be a title such as “Device 1” that is pre-decided by a user or a manufacturer, or may be a title directly input by a user.

Also, in FIG. 3, names of the pictures 310 stored in the digital camera can be used as a title of a virtual program. However, such a title of the virtual program may be decided by using at least one of a title indicating a type of the contents, a title pre-decided by a user or a manufacturer, and a title directly input by a user. For example, titles such as “moving picture 1”, “picture 1”, “content 1”, “data 1” and the like may be used as the title of the virtual program.

When such a generated user interface 320 is output via a broadcasting receiving apparatus, a user inputs a control command by using an external input device.

For example, when the user inputs a command related to a reproduction of the content “DSC20070905_{—}001” of the block 322 in FIG. 3, a content having a title called “DSC20070905_{—}001” is reproduced via the broadcasting receiving apparatus. Also, the user may input a command related to a deletion of the content “DSC20070905_{—}001” or may input a command related to an execution of a program when the content “DSC20070905_{—}001” is the program to perform a specific operation.

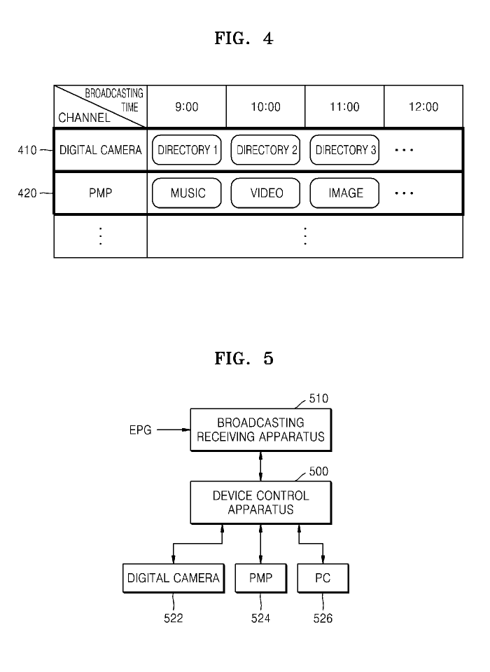

FIG. 4 is a diagram illustrating a user interface according to another embodiment of the present general inventive concept.

FIG. 4 is a diagram for illustrating various examples of the user interface that may be embodied according to the present general inventive concept.

In the case where contents stored in a digital camera are in a structure including directories, a block 410 is an example in which each of the directories is matched with each virtual program.

For example, in the case where the contents are divided and stored in a directory 1, a directory 2, and a directory 3 of the digital camera, the user interface may be generated as the block 410. To be more specific, pictures taken in different dates may be stored in each of the directories according to the different dates, and in this case, titles of the virtual programs may not be the directory 1, the directory 2, and the directory 3 as illustrated in the block 410 but the titles may be the different dates, such as 20070901, 20070902, and 20070903, on which the pictures were taken.

A block 420 is another example of the current embodiment of the present general inventive concept. In the block 420, various types of contents, which are stored in a portable multimedia player (PMP), are classified according to category and matched with virtual programs.

In the block 420, each of the categories “Music, Video, and Image”, classifying the contents stored in the PMP, is matched with each of the virtual programs titled “Music, Video, and Image”, and is indicated in the user interface.

When a user selects the title “Music” of the block 420, the user may input a command related to an output of a list about the contents corresponding to the title “Music”, or may input a command related to a reproduction or a deletion of the contents corresponding to the title “Music”.

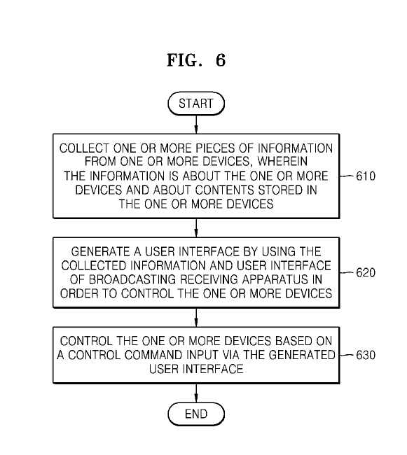

FIG. 5 is a block diagram illustrating a device control apparatus 500 by using a broadcasting receiving apparatus 510, according to another embodiment of the present general inventive concept.

Referring to FIG. 5, the device control apparatus 500 is wirelessly or wiredly connected to the broadcasting receiving apparatus 510 and devices 522, 524, and 526 which are respectively a digital camera, a PMP, and a personal computer (PC). However, according to other embodiments, the device control apparatus 500 may be equipped in the broadcasting receiving apparatus 510.

Referring to FIG. 5, the device control apparatus 500 collects one or more pieces of information from the devices 522, 524, and 526, wherein the information is about each of the devices 522, 524, and 526 and about contents stored in each of the devices 522, 524, and 526. Also, the device control apparatus 500 receives an EPG received by the broadcasting receiving apparatus 510.

The device control apparatus 500 generates a user interface by using the information collected from each of the devices 522, 524, and 526 and by using the EPG received by the broadcasting receiving apparatus 510. After that, the device control apparatus 500 outputs the generated user interface via the broadcasting receiving apparatus 510.

A user inputs a control command to control each of the devices 522, 524, and 526 via the user interface output by the broadcasting receiving apparatus 510, so that each of the devices 522, 524, and 526 is controlled according to the control command.

For example, the user may control the contents, which are stored in the device 522, to be transmitted to the device 524, or may control the device 526 to download new content and to output the downloaded content in the broadcasting receiving apparatus 510.

However, the above example is related to the case in which all of the devices 522, 524, and 526 are connected to the device control apparatus 500. If one of the devices 522, 524, and 526 is not connected to the device control apparatus 500, the user interface is not generated and such device cannot be controlled.

FIG. 6 is a flowchart illustrating a method of controlling a device by using a broadcasting receiving apparatus, according to an embodiment of the present general inventive concept.

In operation 610, one or more pieces of information is collected from one or more devices, wherein the information is about each of the one or more devices and about contents stored in each of the one or more devices.

In operation 620, a user interface is generated by using the collected information and a user interface of the broadcasting receiving apparatus, so as to control the one or more devices. Next, the device control apparatus generates the user interface by using the information collected from each of the devices and by using the EPG received by the broadcasting receiving apparatus.

According to other embodiments, the user interface may be generated by using an EPG received by the broadcasting receiving apparatus.

In operation 630, when a control command is input via the generated user interface, the one or more devices are controlled based on the control command. The control command may be input by using an external input device such as a remote controller.

Various embodiments of the present general inventive concept illustrate one or more pieces of information from one or more devices being collected, wherein the information is about each of the one or more devices and about the contents stored in each of the one or more devices. The user interface to control the one or more devices is generated by using the collected information and the user interface of the broadcasting receiving apparatus, and the one or more devices based on the control command input via the generated user interface is controlled. By doing so, the present general inventive concept can enable users to intuitively control various types of digital devices.

The present general inventive concept can also be embodied as computer-readable codes on a computer-readable medium. The computer-readable medium can include a computer-readable recording medium and a computer-readable transmission medium. The computer-readable recording medium is any data storage device that can store data that can be thereafter read by a computer system. Examples of the computer-readable recording medium include read-only memory (ROM), random-access memory (RAM), CD-ROMs, magnetic tapes, floppy disks, and optical data storage devices. The computer-readable recording medium can also be distributed over network coupled computer systems so that the computer-readable code is stored and executed in a distributed fashion. The computer-readable transmission medium can transmit carrier waves or signals (e.g., wired or wireless data transmission through the Internet). Also, functional programs, codes, and code segments to accomplish the present general inventive concept can be easily construed by programmers skilled in the art to which the present general inventive concept pertains.

While this present general inventive concept has been particularly illustrated and described with reference to exemplary embodiments thereof, it will be understood by one of ordinary skill in the art that various changes in form and details may be made therein without departing from the spirit and scope of the general inventive concept as defined by the appended claims. The exemplary embodiments should be considered in a descriptive sense only and not for purposes of limitation. Therefore, the scope of the general inventive concept is defined not by the detailed description of the general inventive concept but by the appended claims, and all differences within the scope will be construed as being included in the present general inventive concept.

What is claimed is:

1. A method of controlling one or more devices by using a broadcasting receiving apparatus, the method comprising:
collecting one or more pieces of information from the one or more devices such that the information corresponds to the one or more devices and contents stored in the one or more devices;
generating a user interface by using the collected information and a user interface of the broadcasting receiving apparatus in order to control the one or more devices; and
controlling the one or more devices based on a control command input via the generated user interface.

2. The method of claim 1, further comprising:
receiving an EPG (electronic program guide),
wherein the generating of the user interface includes generating the user interface based on the received EPG and the collected information.

3. The method of claim 2, wherein the generating of the user interface further comprises:
generating one or more virtual channels in the received EPG;
matching the one or more devices with the one or more virtual channels by using the collected information; and
generating the user interface by using the one or more virtual channels.

4. The method of claim 3, wherein the matching further comprises:
generating one or more virtual programs in the received EPG; and
matching the contents stored in the one or more devices with the one or more virtual programs.

5. The method of claim 3, wherein when the contents are stored in the one or more devices having a structure including directories, the matching further comprises:
matching the directories of the one or more devices with the one or more virtual channels generated in the received EPG or with the one or more virtual programs generated in the received EPG.

6. The method of claim 3, wherein the matching further comprises:
matching each category classifying the contents stored in the one or more devices, with each of the one or more virtual programs generated in the received EPG.

7. The method of claim 4, wherein titles of the one or more virtual channels are determined by using one of a title indicating each type of the one or more devices, a serial number of each of the one or more devices, a title pre-decided by a user or a manufacturer, and a title directly input by a user, and
titles of the one or more virtual programs are decided by using one of a title indicating a type of the contents, a title pre-decided by a user or a manufacturer, and a title directly input by a user.

8. The method of claim 1, wherein the controlling comprises:
one or more of controlling the contents, which are stored in the one or more devices, to be deleted or to be executed, controlling the contents to be reproduced via the broadcasting receiving apparatus, or controlling the contents to be transmitted between each of the one or more devices.

9. A device control apparatus to control one or more devices by using a broadcasting receiving apparatus, the apparatus comprising:
an information collection unit to collect one or more pieces of information from the one or more devices such that the information corresponds to the one or more devices and contents stored in the one or more devices;
a user interface generation unit to generate a user interface by using the collected information and a user interface of the broadcasting receiving apparatus in order to control the one or more devices;
an input unit to receive a control command via the generated user interface; and
a control unit to control the one or more devices based on the input control command.

10. The device control apparatus of claim 9, further comprising:
a receiving unit to receive an EPG
wherein the user interface generation unit generates the user interface based on the received EPG and the collected information.

11. The device control apparatus of claim 10, wherein the user interface generation unit further comprises:
a match unit to generate one or more virtual channels in the received EPG, and to match the one or more devices with the one or more virtual channels by using the collected information; and
an interface generation unit to generate the user interface by using the one or more virtual channels.

12. The device control apparatus of claim 11, wherein the match unit generates one or more virtual programs in the received EPG and matches the contents stored in the one or more devices with the one or more virtual programs.

13. The device control apparatus of claim 11, wherein when the contents are stored in the one or more devices having a structure including directories, the match unit matches the directories of the one or more devices with the one or more virtual channels generated in the received EPG or with the one or more virtual programs generated in the received EPG.

14. The device control apparatus of claim 11, wherein the match unit matches each category, classifying the contents stored in the one or more devices, with each of the one or more virtual programs generated in the received EPG.

15. The device control apparatus of claim 12, wherein titles of the one or more virtual channels are decided by using one of a title indicating each type of the one or more devices, a serial number of each of the one or more devices, a title pre-decided by a user or a manufacturer, and a title directly input by a user, and
titles of the one or more virtual programs are decided by using one of a title indicating the type of the contents, a title pre-decided by a user or a manufacturer, and a title directly input by a user.

16. The device control apparatus of claim 9, wherein the control unit controls the contents, which are stored in the one or more devices, to be deleted or to be executed, controls the contents to be reproduced via the broadcasting receiving apparatus, or controls the contents to be transmitted between each of the one or more devices.

17. A computer-readable recording medium having embodied thereon a computer program to execute a method, the method comprising:
collecting one or more pieces of information from the one or more devices such that the information corresponds to the one or more devices and contents stored in the one or more devices;
generating a user interface by using the collected information and a user interface of the broadcasting receiving apparatus in order to control the one or more devices; and
controlling the one or more devices based on a control command input via the generated user interface.

18. A control apparatus usable with a broadcasting receiving apparatus, the control apparatus comprising:
a user interface generation unit to generate a user interface by using information from one or more devices and an electronic program guide received by the broadcasting receiving apparatus,
wherein the user interface is generated in order to control the one or more devices.

19. The control apparatus of claim 18, further comprising:
a control unit to control the one or more devices based on an input control command.

20. The control apparatus of claim 18, wherein the one or more devices comprise:
at least one of a digital camera, a portable media player and a personal computer.
